(19) United States
(12) Patent Application Publication
(10) Pub. No.: US 2013/0241090 A1
(43) Pub. Date: Sep. 19, 2013

(54) METHOD OF MANUFACTURING AN OPTICAL ELEMENT

(71) Applicants: Jun-ichi Sakamoto, Yokohama-shi (JP); Junji Terada, Tokyo (JP); Masaya Hisamatsu, Yokohama-shi (JP)

(72) Inventors: Jun-ichi Sakamoto, Yokohama-shi (JP); Junji Terada, Tokyo (JP); Masaya Hisamatsu, Yokohama-shi (JP)

(73) Assignee: CANON KABUSHIKI KAISHA, Tokyo (JP)

(21) Appl. No.: 13/989,451

(22) PCT Filed: Dec. 8, 2011
(86) PCT No.: PCT/JP2011/078977

§ 371 Date: May 24, 2013

(30) Foreign Application Priority Data
Dec. 17, 2010 (JP) 2010-281488

(51) Int. Cl. G02B 5/00

(52) U.S. Cl. CPC G02B 5/00
USPC 264/1.7; 264/2.6

(57) ABSTRACT

Provided is a method of manufacturing an optical element having a structure, which is represented by a one-dimensional lattice, with high yield with the use of a sol-gel material. A titanium based sol-gel material is applied onto a substrate (1), and then is subjected to vacuum drying to form a titania sol layer (2) corresponding to a dried sol-gel film. Onto the titania sol layer (2), a line-and-space structure is transferred by embossing using a mold (3), and then the mold (3) is separated. Thus, a titania sol layer (4) having the structure is formed. Next, heating is performed to accelerate the dehydration condensation reaction of the sol-gel material to cure the sol-gel material, and thus a titanium oxide structure portion (5) having the line-and-space structure is formed.

### TECHNICAL FIELD

The present invention relates to a method of manufacturing an optical element having a subwavelength structure.

### BACKGROUND ART

In recent years, there have been many proposals of forming an optical element, such as an antireflection member, a polarizing plate, and a phase plate, with a structure portion having a subwavelength structure. As a method of manufacturing the structure at low cost, an embossing method may be exemplified. A material usable in molding by the embossing method is a thermoplastic or thermosetting material, and, for example, a synthetic resin material or a sol-gel material may be exemplified.

As a material onto which a structure is to be transferred by embossing to form an optical element, it is desired to select a material which is excellent in transparency, thermal resistance, and durability, and further, has a high refractive index. From this viewpoint, in particular, a method of manufacturing an optical element by embossing a sol-gel material which can realize high refractive index is suitable as a method of manufacturing a high-performance optical element at low cost. For example, a technology disclosed in Patent Literature 1 is known.

### CITATION LIST

### Patent Literature

PTL 1: Japanese Patent Application Laid-Open No. 2006-150807

### SUMMARY OF INVENTION

### Technical Problem

When a material having high chemical reactivity, such as a sol-gel material, is used, in a conventional technology, it has been difficult to peel a molded product from a mold member. Therefore, in Patent Literature 1, a peeling layer is formed on the surface of the mold material, to thereby enhance the mold releasing property between the sol-gel material and the mold surface.

Further, in the disclosed process, the sol-gel material is poured into a mold with a molding surface directed upward, and is then heated to obtain a gel-state. After that, a glass plate is placed on the sol-gel material and curing processing is performed at 200° C. for 30 minutes. Then, after being naturally cooled, the sol-gel material is demolded to obtain a molded product having the same groove pattern as that on the original mold formed on one surface thereof.

Generally, when the sol-gel material is heated to a certain temperature or larger after being turned into a gel, a dehydration condensation reaction thereof is rapidly accelerated to cause volume shrinkage. The shrinkage amount thereof depends on the material type, but is about several to 50%. Therefore, the cured sol-gel material has a large tensile stress with respect to a substrate or a mold being held in contact thereto.

Therefore, in a case where the dehydration condensation reaction is accelerated and completed while the mold and the sol-gel material are held in contact with each other, the sol-gel material greatly shrinks with respect to the mold, which causes difficulty in demolding. Further, when it is attempted to forcibly perform demolding under this state in which the demolding is difficult, there is a possibility that the structure made of the sol-gel material is broken. This phenomenon is difficult to avoid even if a peeling layer is provided to the mold. Further, in cases where the pattern size to be obtained is fine, has a high aspect ratio, and is large in size, the possibility that the structure is broken further increases.

### Solution to Problem

The present invention has an object to provide a method of manufacturing an optical element, which is capable of, in embossing of a sol-gel material, performing demolding with ease without breaking a structure formed with subwavelength pitch, to thereby enable high yield manufacturing.

A method of manufacturing an optical element having a structure according to a first aspect of the present invention includes: applying a sol-gel material onto a substrate and drying the applied sol-gel material to form a dried sol-gel film; pressing a mold against the dried sol-gel film to transfer the structure, and then separating the mold; and heating the dried sol-gel film onto which the structure has been transferred to a temperature at which a dehydration condensation reaction of the sol-gel material is accelerated to perform curing processing.

A method of manufacturing an optical element having a structure according to a second aspect of the present invention includes: applying a sol-gel material onto a first substrate and drying the applied sol-gel material to form a dried sol-gel film; pressing a mold against the dried sol-gel film to transfer the structure, and then separating the mold; and under a state in which a structure top portion of the dried sol-gel film onto which the structure has been transferred is brought into contact with a second substrate, heating the dried sol-gel film to a temperature at which a dehydration condensation reaction of the sol-gel material is accelerated to perform curing processing and bonding with the second substrate.

A method of manufacturing an optical element having a structure according to a third aspect of the present invention includes: preparing a first substrate including a mold release layer; applying a sol-gel material onto the peeling layer of the first substrate and drying the applied sol-gel material to form a dried sol-gel film; pressing a mold against the dried sol-gel film to transfer the structure, and then separating the mold; under a state in which a structure top portion of the dried sol-gel film onto which the structure has been transferred is brought into contact with a second substrate, heating the dried sol-gel film to a temperature at which a dehydration condensation reaction of the sol-gel material is accelerated to perform curing processing and bonding with the second substrate; and melting the peeling layer to peel the first substrate.

### Advantageous Effects of Invention

By applying the sol-gel material to the substrate, drying the sol-gel material, and then transferring the structure onto the dried sol-gel film, demolding can be easily performed, which prevents the structure from being broken. With this, it is possible to manufacture the optical element with high yield.

Further features of the present invention will become apparent from the following description of exemplary embodiments with reference to the attached drawings.

### BRIEF DESCRIPTION OF DRAWINGS

FIGS. 1A, 1B, 1C and 1D are views illustrating steps of a method of manufacturing an optical element according to Example 1 of the present invention.

FIGS. 2A and 2B are views illustrating steps of a method of manufacturing an optical element according to Example 2 of the present invention.

FIGS. 3A, 3B, 3C and 3D are views illustrating steps of a method of manufacturing an optical element according to Example 3 of the present invention.

FIG. 4 is a schematic sectional view illustrating a section of an optical element according to Example 4 of the present invention.

FIGS. 5A, 5B, 5C, 5D, 5E, 5F, 5G and 5H are views illustrating steps of a method of manufacturing an optical element according to Example 5 of the present invention.

### DESCRIPTION OF EMBODIMENTS

In a first embodiment of the present invention, an optical element is manufactured, which has a structure formed on a substrate by embossing of a sol-gel material. First, the sol-gel material applied onto the substrate is dried to obtain a dried sol-gel film. Then, a mold is pressed against the dried sol-gel film to transfer the structure, and thus a structure portion (sol-gel structure portion) of the optical element is formed. Next, the mold is separated, and then heating is performed to accelerate the dehydration condensation reaction of the sol-gel material to cure the sol-gel material.

By drying the sol-gel material and transferring the structure under a state in which no volume shrinkage occurs in the material, demolding is possible without requiring a large demolding force. After the demolding, heating is performed to accelerate the dehydration condensation reaction of the sol-gel material to cure the sol-gel material, and thus the structure is stabilized.

In a case where the sol-gel material applied to the substrate is heated in a drying step, the curing is accelerated. When the curing is accelerated, a large pressure is required in an embossing step, and hence there is a fear that the substrate is broken or there is a possibility that the structure cannot be transferred onto the sol-gel material. As a countermeasure, by using a vacuum drying method capable of drying a solvent in a non-heating state, the sol-gel material can be dried while suppressing the chemical reaction progress of the sol-gel material, and thus a dried film of the sol-gel material (dried sol-gel film), onto which the structure can be transferred with an appropriate pressure, is formed. This method is employed in a case where the structure has a line-and-space structure, a hole structure, a post structure, or the like with a pitch equal to or smaller than the subwavelength and an aspect ratio equal to or larger than 1.5. The line-and-space structure refers to a structure in which linear structures are repeatedly formed with a space therebetween at a pitch equal to or smaller than the subwavelength, the linear structures having an aspect ratio corresponding to a value obtained by dividing the line height by the line width of 1.5 or larger. The hole structure refers to a structure in which, for example, pillar holes are formed at a pitch equal to or smaller than the subwavelength, the pillar holes having an aspect ratio corresponding to a value obtained by dividing the pillar height by the pillar diameter of 1.5 or larger. The post structure refers to a structure in which, for example, pillar structures are repeatedly formed at a pitch equal to or smaller than the subwavelength, the pillar structures having an aspect ratio corresponding to a value obtained by dividing the pillar height by the pillar diameter of 1.5 or larger.

When a structure with high aspect ratio is to be obtained in a structure equal to or smaller than the subwavelength, the structure portion becomes brittle. The structure is required to be cured to cause shrinkage after being separated from the mold, otherwise a part or the whole of the structure is broken due to the stress. In the current technology, the minimum pitch in a mold capable of being stably manufactured is about 50 nm, and the maximum value of the aspect ratio (ratio of height to width) in this size region is about 10.

The mold material to be used is required to be a mold material in which a line width, a space width, a line height, a space height, and the like are adjusted in conformity to the final structure to be obtained, in consideration of a curing and shrinking amount of the sol-gel material. The layer of the sol-gel material, onto which the structure has been transferred, functions as a one-dimensional lattice in a case of the line-and-space structure, and thus a layer which has different refractive indexes in two in-plane directions can be obtained. Further, in the case of the hole structure or the post structure having a uniform arrangement, a layer functioning as substantially a homogeneous film can be obtained. When the rate of the spaces is large, a layer having a very low refractive index can be obtained, which has very excellent optical characteristics such as antireflection characteristics. In the case of the post structure or the hole structure, the shapes of the structures and the holes are not particularly limited, and may be a triangle pole and a quadrangular pyramid as well as a pillar and a circular cone.

In a second embodiment of the present invention, heating is performed under a state in which a second substrate is additionally brought into contact with a top portion of the structure portion (sol-gel structure portion) of the dried sol-gel film onto which the structure has been transferred. In this manner, the dehydration condensation reaction is accelerated to bond the second substrate surface and the top portion of the structure portion, and at the same time, the structure portion is cured. In this case, the second substrate is bonded by utilizing the reactivity of the sol-gel material in a dried state. The sol-gel material is linked to other atoms or molecules by a covalent bond in the process of the dehydration condensation reaction. Therefore, the second substrate surface which is brought into contact with the surface of the active sol-gel structure is covalently-bonded in the process of the dehydration condensation reaction of the sol-gel material, to thereby realize a firm bonding.

It is desired that the top portion of the structure portion be provided in plane contact with the second substrate in order to generate a firm bonding force thereto. Therefore, because a bottom portion of the structure of the mold to be used forms the top portion of the structure portion after transfer, the mold to be used is desired to have structures formed of not dots and lines but planes.

Further, in order to obtain the function as an optical element, the second substrate is required to be made of a material which is transparent and endurable at a high temperature state in which the sol-gel material performs the dehydration condensation reaction. From this viewpoint, optical glass is the best material.

Conventionally, an optical element requiring a sandwich structure with glass has been manufactured through adhesion with the use of an optical adhesive and the like. In contrast, when the manufacturing method of the present invention is used, the optical element requiring a sandwich structure with glass can be manufactured without an adhesive. The first substrate used here functions as a part of the optical element, and hence, similarly to the above-mentioned second substrate, the first substrate is required to be made of a material which is transparent and endurable at a high temperature state in which the sol-gel material performs the dehydration condensation reaction. From this viewpoint, optical glass is the best material.

In a third embodiment of the present invention, as the first substrate in the second embodiment, there is used a substrate having a peeling layer formed thereon, which melts at a temperature higher than a temperature at which the structure portion starts its dehydration condensation reaction. In this manner, the substrate is heated to a temperature equal to or higher than the temperature at which the peeling layer melts, to thereby peel the first substrate from the sol-gel structure portion.

As described above, with the use of the reactivity of the sol-gel material in a vacuum dried state, the dehydration condensation reaction of the sol-gel material is accelerated along with the temperature increase, and thus the top portion of the sol-gel structure portion is bonded to the second substrate. In this process, the peeling layer formed at the interface between the first substrate and the sol-gel structure portion reaches to a melting point thereof to melt, and thus the first substrate is peeled from the sol-gel structure portion bonded to the second substrate.

Here, the starting temperature of the dehydration condensation reaction of the sol-gel material ranges from several tens of degrees C. to one hundred and several dozen degrees C., and hence as the peeling layer, a commercially available wax or low-melting-point metal, which is capable of being spin coated, can be used. The residue of the peeling layer remains on the sol-gel structure portion surface which has been transferred onto the second substrate, and hence it is necessary to remove the residue of the peeling layer. From this viewpoint, a wax capable of being cleaned with a solvent is suitably used.

A material which can be used as the peeling layer is required to be a material which is capable of melting at the melting point of the substrate or a glass transition temperature or lower. Further, the first substrate to be peeled is not required to be transparent, and is only required to be a substrate which has a high melting point and high plane accuracy.

By using, as the second substrate, a substrate onto which a one-layer or multilayer stacking structure is transferred in advance by a method of peeling the first substrate after the structure is transferred in steps similar to those described above, it is possible to manufacture an optical element having a hollow structure between the layers.

The respective layers can be molded by using individual molds, and the structures of the respective layers are only required to be structures that can obtain desired optical characteristics. Therefore, the structures of the molds are not particularly limited. Further, the sol-gel materials of the respective layers are only required to have various refractive indexes, and also only required to be sol-gel materials that can obtain desired optical characteristics.

When a stacking dried sol-gel film subjected to vacuum drying is provided to the second substrate after the sol-gel material is applied, the bonding force between the second substrate and the top portion of the sol-gel structure portion can be enhanced, and at the same time, optical characteristics of the optical element to be manufactured are enhanced.

In a case where the first and second substrates remain as components of the optical element, the optical element to be used and manufactured may be provided with multiple interference layers so that optical characteristics are optimized in advance.

The sol-gel material to be used in the present invention can range from a high refractive index material to a low refractive index material, and is not particularly limited as long as the material can obtain desired optical characteristics.

### Example 1

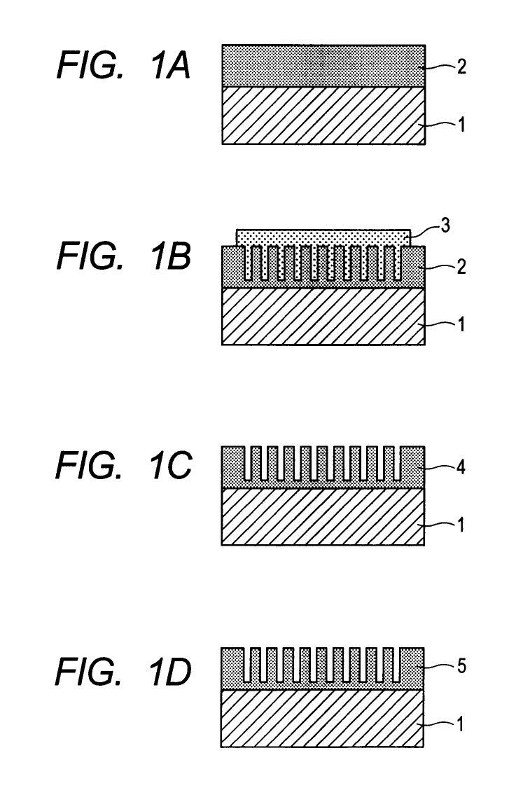

With steps illustrated in FIGS. 1A to 1D, the optical element was manufactured. First, as illustrated in FIG. 1A, a Φ4-inch substrate 1 was prepared with a substrate member subjected to cleaning (S-BSL 7 manufactured by OHARA INC.). Next, the sol-gel material (titanium oxide based sol-gel material TI-204-2K manufactured by Rasa Industries, Ltd.) was spin coated at 2,500 RPM for 30 seconds, and then was rapidly subjected to vacuum drying, to thereby form a titania sol layer 2 corresponding to the dried sol-gel film. The vacuum drying conditions of 25° C. in temperature and 13.3 Pa in degree of vacuum were maintained for one minute. The thickness of the titania sol layer 2 was 226 nm. Here, the vacuum drying conditions will change depending on the sol-gel material used. The degree of vacuum is desired to be equal to or less than the vapor pressure of the main solvent constituting the sol-gel material at a temperature at which the vacuum state is maintained. However, since rapidly reducing the pressure to or below the vapor pressure may generate bubble-shaped defects in the dried film, it is necessary to gradually exhaust to a predetermined degree of vacuum. Furthermore, the temperature will also change depending on the sol-gel material used. The upper limit temperature can be determined by dynamic viscoelasticity measurement of the sol-gel material used. For the material used in this example, it became difficult to transfer the structure at an elastic constant of about 1 kPa, and the temperature at that time was about 80° C.

Next, as illustrated in FIG. 1B, a mold 3 made of nickel was pressed against the obtained titania sol layer 2 under a pressure of 30 kg/cm², to thereby manufacture a titania sol layer 4 corresponding to the dried sol-gel film onto which the structure was transferred. The mold made of nickel used here had a line-and-space structure with a line of 50 nm, a space of 90 nm, a line height of 300 nm (aspect ratio 6.0), and a pattern area of □30 mm.

Next, as illustrated in FIG. 1C, the mold 3 was separated. The titania sol layer 4 onto which the structure had been transferred had a structure with a line of 88 nm, a space of 52 nm, and a line height of 298 nm (aspect ratio 3.4). Further, under the structure, a continuous film portion having a thickness of 34 nm existed.

Next, as illustrated in FIG. 1D, the substrate 1 having the titania sol layer 4 onto which the structure had been transferred was placed on a hot plate to be heated, to thereby perform curing processing at a temperature of 350° C., which accelerates the dehydration condensation reaction of the sol-gel material, for 30 minutes. With this, a titanium oxide structure portion 5 corresponding to the sol-gel structure portion was obtained, which had a line-and-space structure with a line of 70 nm, a space of 70 nm, and a line height of 238 nm (aspect ratio 3.4). The refractive index of the titanium oxide at the wavelength of 550 nm was 2.07. Further, under the structure, the continuous film portion having a thickness of 27 nm existed.

The optical element having the line-and-space structure of titanium oxide manufactured by embossing functions as a one-dimensional lattice having refractive index anisotropy. The refractive index at the wavelength of 550 nm with respect to an oscillating component of light parallel to the line (TE polarized light) is 1.62, and the refractive index at the wavelength of 550 nm with respect to an oscillating component of light perpendicular to the line (TM polarized light) is 1.27. The optical element obtained in this example functioned as a phase plate.

### Example 2

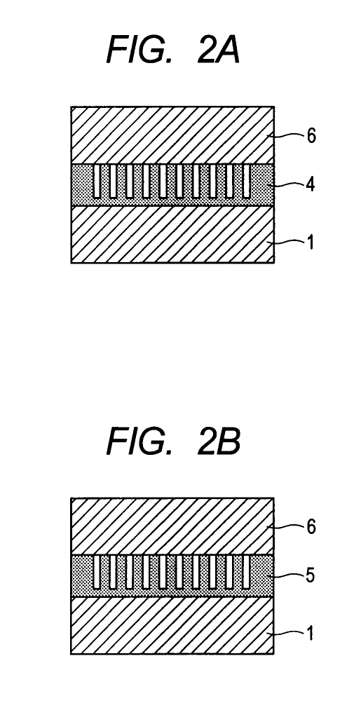

With steps illustrated in FIGS. 1A to 1D and FIGS. 2A and 2B, the optical element was manufactured. First, with steps similar to those of Example 1 illustrated in FIGS. 1A to 1C, the titania sol layer 4 was manufactured on the first substrate 1. After that, as illustrated in FIG. 2A, a glass substrate 6 corresponding to the second substrate was arranged on the line structure top portion of the titania sol layer 4 so that the surface of the glass substrate 6 was held in contact with the line structure top portion. At this time, a pressure was applied from the rear surface of the glass substrate 6 so that an interference fringe could not be visually observed at the interface.

Next, the titania sol layer 4 which had been sandwiched with glass was subjected to curing processing on a hot plate at a temperature of 350° C. for 30 minutes. In this manner, as illustrated in FIG. 2B, the optical element was obtained, in which the structure top portion of the titanium oxide structure portion 5 having the structure and the surface of the glass substrate 6 were firmly bonded to each other.

The structure of the optical element manufactured here is protected with glass, and hence is strong against structure breakage due to the external force. The optical element obtained in this example functioned as a phase plate.

### Example 3

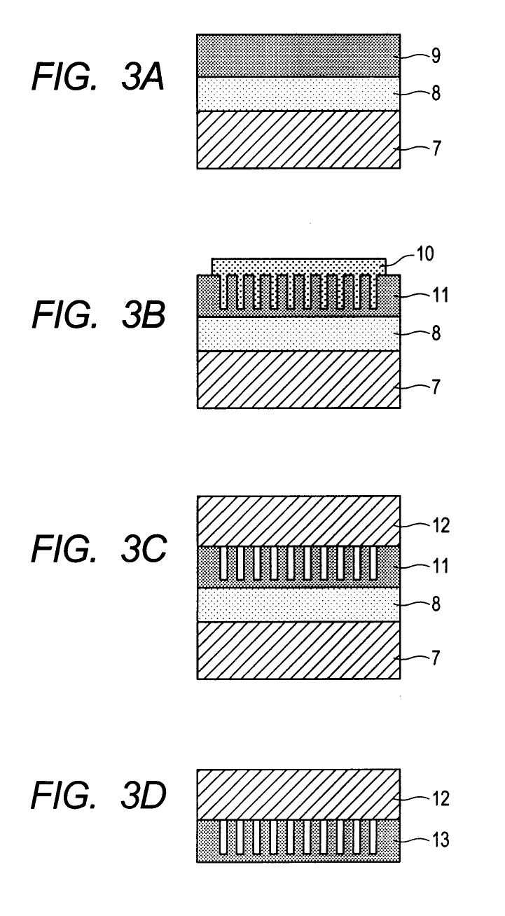

With steps illustrated in FIGS. 3A to 3D, the optical element was manufactured. In a first step, as illustrated in FIG. 3A, a first substrate 7 was prepared, which was a Φ4-inch quartz wafer substrate subjected to cleaning. In a second step, a coating material having a low melting point (Skycoat BRT #55 manufactured by NIKKA SEIKO CO., LTD.) was spin coated at 2,000 RPM for 60 seconds, and then pre-baking was performed on a hot plate at 60° C. for 5 minutes, to thereby form a peeling layer 8.

In a third step, the sol-gel material (titanium oxide based sol-gel material TI-204-2K manufactured by Rasa Industries, Ltd.) was spin coated on the peeling layer 8 at 700 RPM for 60 seconds, and then was rapidly subjected to vacuum drying, to thereby form a titania sol layer 9 corresponding to the dried sol-gel film. The thickness of the titania sol layer 9 was 439 nm.

As illustrated in FIG. 3B, in a fourth step, a mold 10 made of nickel was pressed against the obtained titania sol layer 9 under a pressure of 30 kg/cm², to thereby transfer the structure of the mold 10. The mold made of nickel used here had a line-and-space structure with a line of 50 nm, a space of 90 nm, a line height of 410 nm (aspect ratio 8.2), and a pattern area of □30 mm.

In a fifth step, the mold 10 was separated to obtain a titania sol layer 11 onto which the structure had been transferred. The titania sol layer 11 had a structure with a line of 88 nm, a space of 52 nm, and a line height of 375 nm (aspect ratio 4.3). Further, under the structure, a continuous film portion having a thickness of 166 nm existed.

In a sixth step illustrated in FIG. 3C, onto the line structure top portion of the titania sol layer 11 onto which the structure had been transferred, a glass substrate 12 corresponding to the Φ4-inch second substrate made of a glass substrate member subjected to cleaning (S-TIH 53 manufactured by OHARA INC.) was arranged so that the surface of the glass substrate 12 was held in contact with the line structure top portion. At this time, a pressure was applied from the rear surface of the first substrate 7 so that an interference fringe could not be visually observed at the interface.

In a seventh step, the second substrate 12 was arranged on a hot plate while pressurizing the first substrate 7, and then heating was performed at a temperature of 150° C. Then, at the time point at which the peeling layer 8 melted, the pressurizing was stopped, and the first substrate 7 was peeled from the titania sol layer 11 by sliding the first substrate 7 in parallel to the plane. Then, cooling was once performed, and cleaning was performed with isopropyl alcohol. In this manner, the residue of the peeling layer was removed and cleaned.

In an eighth step illustrated in FIG. 3D, curing processing was performed on a hot plate at a temperature of 350° C. for 30 minutes, to thereby obtain a titanium oxide structure portion 13 corresponding to the sol-gel structure portion having the structure. The obtained structure had a line of 70 nm, a space of 70 nm, and a line height of 300 nm (aspect ratio 4.3). Further, the thickness of the uppermost continuous film portion of the titanium oxide was 133 nm.

### Example 4

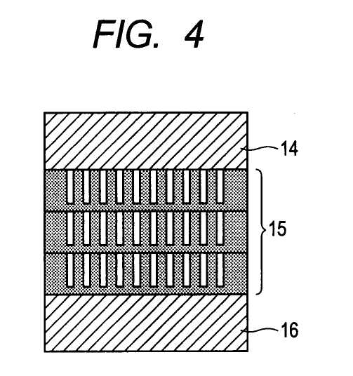

In this example, as illustrated in FIG. 4, the process was progressed up to the seventh step in the same way as Example 3 except that the glass substrate used in the fifth step in Example 3 was changed to a right angle prism 14. In this manner, a substrate in which the titanium oxide structure portion had been transferred onto the right angle prism 14 was obtained. With this substrate as the second substrate, the process was progressed up to the seventh step of Example 3 again, to thereby obtain the second substrate in which, onto the right angle prism 14, a two-layer titanium oxide structure portion corresponding to the sol-gel structure portion having a stacking structure was stacked.

Next, a right angle prism 16 was used as the first substrate of Example 2, and the titania sol layer onto which the structure had been transferred was formed on the right angle prism 16. Then, the above-mentioned two-layer titanium oxide structure portion of the second substrate was brought into contact with the line structure top portion of the titania sol layer of the first substrate. Then, those layers were sandwiched with a jig so that an interference fringe could not be visually observed, and heating was performed with a clean oven at 350° C. for 1 hour. After cooling, the jig was removed to obtain the optical element.

FIG. 4 is a schematic sectional view of the obtained optical element. A stacked titanium oxide structure portion 15 is provided between the right angle prisms 14 and 16. The line direction of the titanium oxide structure portion of each layer is arranged in a longitudinal direction of an inclined surface of each right angle prism.

The obtained optical element functioned as a polarizing beam splitter exhibiting good polarizing characteristics within the incident angle range of 40° to 50° in the entire visible range.

### Example 5

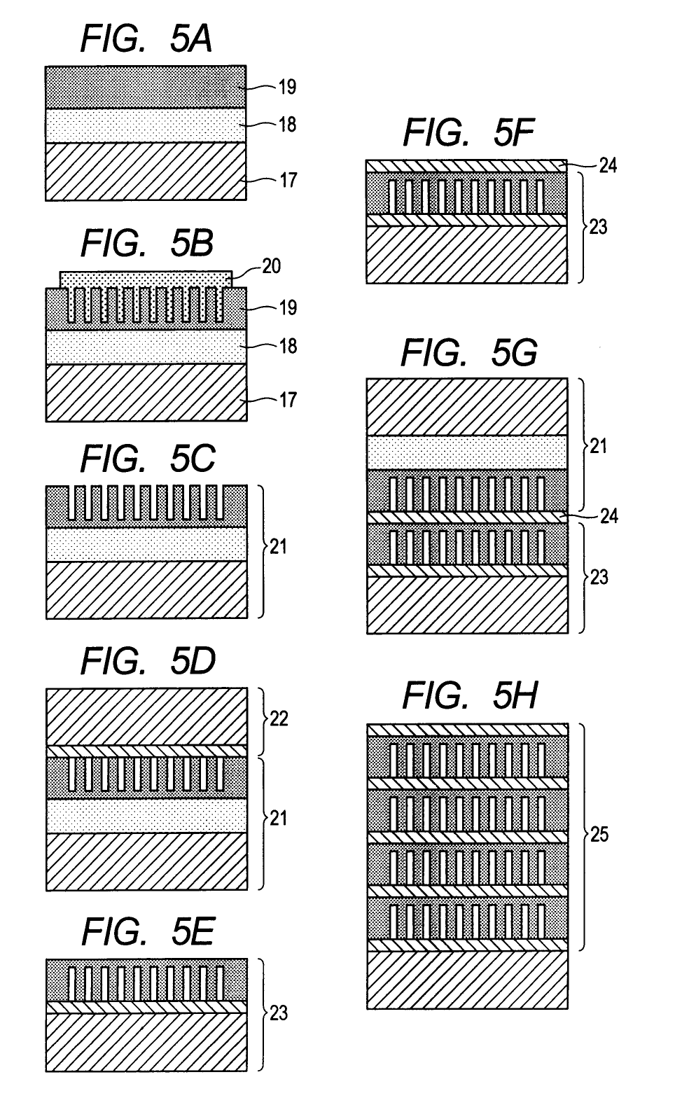

With steps illustrated in FIGS. 5A to 5H, the optical element was manufactured. In a first step, as illustrated in FIG. 5A, a first substrate 17 was cleaned, which was a quartz substrate having a diameter of 10 mm and a thickness of 1.1 mm. In a second step, a coating material having a low melting point (Skycoat BRT #55 manufactured by NIKKA SEIKO CO., LTD.) was spin coated at 2,000 RPM for 60 seconds, and then pre-baking was performed on a hot plate at 60° C. for 5 minutes, to thereby form a peeling layer 18.

In a third step, the sol-gel material (siloxane based sol-gel material VRS-PRC352N-1K manufactured by Rasa Industries, Ltd.) was spin coated on the peeling layer 18 at 4,800 RPM for 30 seconds, and then was subjected to vacuum drying, to thereby form a dried sol layer 19 corresponding to the dried sol-gel film having a thickness of 66 nm.

As illustrated in FIG. 5B, in a fourth step, the dried sol layer 9 was molded by embossing with a mold 20. The mold used here was a □40-mm mold made of quartz, and had a structure in which a Φ60-nm hole with a depth of 116 nm (aspect ratio 1.9) was provided at a top portion of an equilateral triangular lattice having one side of 100 nm. Further, on the surface of the mold to be used, a surface treatment was performed with a treatment material (OPTOOL DSX manufactured by DAIKIN INDUSTRIES, LTD.). The mold was pressed under a pressure of 50 kg/cm².

As illustrated in FIG. 5C, in a fifth step, the mold 20 is removed, to thereby obtain a stacking transfer substrate 21 having a stacking structure. The steps so far were repeated, thereby manufacturing four stacking transfer substrates 21.

As illustrated in FIG. 5D, in a sixth step, the second substrate formed of a Φ100-mm substrate member (S-BSL 7) having a thickness of 1.1 mm was cleaned. In a seventh step, onto the cleaned substrate, the sol-gel material (titanium oxide based sol-gel material TI-204-1K manufactured by Rasa Industries, Ltd.) was spin coated at 4,500 RPM for 30 seconds, and then was rapidly subjected to vacuum drying, to thereby obtain a substrate 22 with a titania sol layer corresponding to the dried sol-gel film. The thickness of the obtained titania sol layer was 71 nm. In an eighth step, under a state in which the top portion of the structure portion of the stacking transfer substrate 21 obtained in the fifth step and the surface of the substrate 22 with the titania sol layer obtained in the seventh step were brought into contact with each other, the substrate was placed on a hot plate with a 1-kg weight placed thereon. After that, heating was performed at a temperature of 150° C. Then, at a time point at which the peeling layer 18 melted, the weight was removed, and the quartz substrate of the stacking transfer substrate 21 was removed by sliding the quartz substrate in parallel to the plane.

As illustrated in FIG. 5E, in a ninth step, a stacking substrate 23 including the stacking structure after the quartz substrate separation was cooled and cleaned with isopropyl alcohol. In this manner, the residue of the peeling layer was removed and cleaned. In the stacking substrate 23, the continuous film portion at the surface had a thickness of 10 nm and the structure portion had a post structure with a diameter of 59 nm and a height of 114 nm.

As illustrated in FIG. 5F, in a tenth step, in the same way as the seventh step, a titania sol layer 24 corresponding to the stacking dried sol-gel film was provided onto the stacking substrate 23, to thereby form a transfer substrate (second substrate).

As illustrated in FIG. 5G, in an eleventh step, under a state in which the top portion of the structure portion of the stacking transfer substrate 21 obtained in the fifth step was brought into contact with the above-mentioned transfer substrate, the eighth step to the tenth step were repeated. In this manner, a stack structure in which four sol-gel structure portions and four titania sol layers were stacked was obtained.

As illustrated in FIG. 5H, in a twelfth step, by a method similar to the seventh step, an uppermost titania sol layer was provided. Finally, in a thirteenth step, the obtained stack structure was heated on a hot plate at 350° C. for 30 minutes, and then was cooled to obtain the optical element having a stack structure portion 25 of the sol-gel material. The optical element obtained here functions as a high reflecting film exhibiting a reflectance equal to or larger than 99% at the wavelength of 500 nm.

According to the method of manufacturing an optical element of the present invention, a sophisticated optical element can be manufactured. Further, it is possible to manufacture a structure with high aspect ratio in a larger area. Still further, multiple sol-gel material structure portions can be stacked.

### INDUSTRIAL APPLICABILITY

The method of manufacturing an optical element according to the present invention is applicable to manufacturing of an optical element which is a component of, for example, an optical modulation element, an optical device, and an image display device.

While the present invention has been described with reference to exemplary embodiments, it is to be understood that the invention is not limited to the disclosed exemplary embodiments.

This application claims the benefit of Japanese Patent Application No. 2010-281488, filed Dec. 17, 2010, which is hereby incorporated by reference herein in its entirety.

1. A method of manufacturing an optical element having a structure, comprising:
applying a sol-gel material onto a substrate and drying the applied sol-gel material to form a dried sol-gel film;
pressing a mold against the dried sol-gel film to transfer a structure, and then separating the mold; and
heating the dried sol-gel film onto which the structure has been transferred to a temperature at which a dehydration condensation reaction of the sol-gel material is accelerated to perform curing processing.

2. A method of manufacturing an optical element having a structure, comprising:
applying a sol-gel material onto a first substrate and drying the applied sol-gel material to form a dried sol-gel film;
pressing a mold against the dried sol-gel film to transfer a structure, and then separating the mold; and
under a state in which a structure top portion of the dried sol-gel film onto which the structure has been transferred is brought into contact with a second substrate, heating the dried sol-gel film to a temperature at which a dehydration condensation reaction of the sol-gel material is accelerated to perform curing processing and bonding to the second substrate.

3. A method of manufacturing an optical element having a structure, comprising:
preparing a first substrate including a peeling layer;
applying a sol-gel material onto the peeling layer of the first substrate and drying the applied sol-gel material to form a dried sol-gel film;
pressing a mold against the dried sol-gel film to transfer a structure, and then separating the mold;
under a state in which a structure top portion of the dried sol-gel film onto which the structure has been transferred is brought into contact with a second substrate, heating the dried sol-gel film to a temperature at which a dehydration condensation reaction of the sol-gel material is accelerated to perform curing processing and bonding to the second substrate; and
melting the peeling layer to peel the first substrate.

4. The method of manufacturing an optical element according to claim 1, wherein the formation of the dried sol-gel film comprises subjecting the sol-gel material applied onto the substrate to vacuum drying.

5. The method of manufacturing an optical element according to claim 1, wherein the structure comprises one of a line-and-space structure, a hole structure, and a post structure with a pitch equal to or smaller than a subwavelength and an aspect ratio equal to or larger than 1.5.

6. The method of manufacturing an optical element according to claim 2, wherein the second substrate comprises a stacking structure to be stacked on the structure.

7. The method of manufacturing an optical element according to claim 2, wherein the second substrate comprises a stacking dried sol-gel film to be stacked on the structure.
